(19) United States
(12) Patent Application Publication
(10) Pub. No.: US 2021/0379935 A1
(43) Pub. Date: Dec. 9, 2021

(54) Pneumatic Tire

(71) Applicant: The Yokohama Rubber Co., LTD., Minato-ku, Tokyo (JP)

(72) Inventors: Masataka Kubota, Hiratsuka-shi, Kanagawa (JP); Noboru Kuwahara, Minato-ku, Tokyo (JP)

(21) Appl. No.: 16/322,449

(22) PCT Filed: Jul. 31, 2017
(86) PCT No.: PCT/JP2017/027728

§ 371 Date: Jan. 31, 2019

(30) Foreign Application Priority Data
Aug. 1, 2016 (JP) 2016-151348

(51) Int. Cl. B60C 11/03; B60C 11/12

(52) U.S. Cl. CPC B60C 11/0304; B60C 2011/0348; B60C 11/1236; B60C 11/033

(57) ABSTRACT

In a pneumatic tire, among land portions located on both sides of a center circumferential main groove, a first land portion includes a first circumferential narrow groove, and a second land portion includes a second circumferential narrow groove; among regions defined by the first circumferential narrow groove in the first land portion, a side adjacent to the center circumferential main groove is defined as a first-land-portion first region, and the other side is defined as a first-land-portion second region; among regions defined by the second circumferential narrow groove in the second land portion, a side adjacent to the center circumferential main groove is defined as a second-land-portion first region, and the other side is defined as a second-land-portion second region; the first-land-portion first region and the second-land-portion first region have plane regions; and lateral grooves are formed in the first-land-portion second region and the second-land-portion second region.

### TECHNICAL FIELD

The present technology relates to a pneumatic tire.

### BACKGROUND ART

In a pneumatic tire, a plurality of grooves are formed on a tread surface for the purpose of drainage between the tread surface and a road surface when traveling on a wet road surface. Meanwhile, the grooves on the tread surface become a cause of rigidity deterioration of a land portion and a cause of noise generated during traveling of a vehicle. For this reason, in some known pneumatic tires, shapes of the grooves are devised so as to provide the above performances in a compatible manner. For example, in a pneumatic tire described in Japan Patent No. 3963784, lug grooves are formed between main grooves or between main grooves and circumferential narrow grooves to form a block row, and non-through lug grooves are arranged on an outer side of the circumferential narrow grooves in a tire lateral direction, so as to provide pattern noise and ABS (anti-lock braking system) braking performance on a wet road in a compatible manner.

In a pneumatic tire described in Japan Patent No. 5119601, a lug groove is formed in a central land portion located on an inner side in a vehicle mounting direction, the lug groove intersects an adjacent lug groove in a tire circumferential direction and is terminated in the central land portion, and a central land portion located on an outer side in the vehicle mounting direction is only configured by a block row. This configuration improves traveling performance on the wet road surface and on snow while maintaining traveling performance on a dry road surface. In a pneumatic tire described in Japan Unexamined Patent Publication No. 2012-131423, circumferential narrow grooves are formed in circumferential land portions located between a circumferential land portion located at a center in a tire lateral direction and circumferential land portions located on both sides in the tire lateral direction, and by setting one side of the circumferential narrow grooves in the circumferential land portions in the tire lateral direction as a rib body, and setting the other side as a block row, dry traveling performance and wet traveling performance are improved without causing excessive riding comfort deterioration.

In a pneumatic tire described in Japan Unexamined Patent Publication No. 2012-171478, first narrow grooves extending in the tire circumferential direction are formed in a land portion located on both sides in the tire lateral direction of a first circumferential main groove formed on a tire equatorial plane, and one side of the land portion in the tire lateral direction is rib-shaped while the other side is block-shaped, so that deformation of the land portion is reduced during braking and lateral force generation while reducing wear of a tread center section and improving drainage. In a pneumatic tire described in Japan Patent No. 5449209, narrow grooves extending in the tire circumferential direction disposed on a vehicle mounting outer side outside the tire equatorial plane; sipes extending from the narrow grooves to one side in the tire lateral direction so as to intersect the tire equatorial plane, and opening to a circumferential main groove; and a plain rib portion adjacent to the other side of the narrow grooves in the tire lateral direction, which has a circumferential surface shape over an entire surface of a ground contact patch side; are formed on a central rib formed across the tire equatorial plane so as to further improve quietness at the time of traveling.

However, in recent years, dry steering stability and wet steering stability are required at a higher level, and it is very difficult to improve the dry steering stability and the wet steering stability in a balanced manner.

### SUMMARY

The present technology provides a pneumatic tire capable of improving the wet steering stability and the dry steering stability in a well-balanced manner.

A pneumatic tire according to the present technology includes three or more circumferential main grooves formed in a tread surface and extending in a tire circumferential direction; and a plurality of land portions defined by the circumferential main grooves. Among the circumferential main grooves, the circumferential main groove whose position in a tire lateral direction is closest to a tire equator line is defined as a center circumferential main groove. Among the two land portions defined by the center circumferential main groove and located on both sides of the center circumferential main groove in the tire lateral direction, the land portion whose distance to the tire equator line in the tire lateral direction is closer is defined as a first land portion, and the other land portion is defined as a second land portion, the first land portion includes a first circumferential narrow groove extending in the tire circumferential direction. The second land portion includes a second circumferential narrow groove extending in the tire circumferential direction. Among regions of the first land portion defined by the first circumferential narrow groove and located on both sides of the first circumferential narrow groove in the tire lateral direction, a region on a side adjacent to the center circumferential main groove is defined as a first-land-portion first region, and a region on the other side is defined as a first-land-portion second region. Among regions of the second land portion defined by the second circumferential narrow groove and located on both sides of the second circumferential narrow groove in the tire lateral direction, a region on a side adjacent to the center circumferential main groove is defined as a second-land-portion first region, and a region on the other side is defined as a second-land-portion second region. The first-land-portion first region and the second-land-portion first region each include a plane region in which no groove is formed over an entire circumference. A lateral groove extending in the tire lateral direction is formed in the first-land-portion second region and the second-land-portion second region.

In the above pneumatic tire, it is preferable that the first-land-portion first region is disposed at a position including the tire equator line.

In the above pneumatic tire, it is preferable that a width W1 of the first land portion in the tire lateral direction, and a distance W0 in the tire lateral direction from an end portion of the center circumferential main groove on the side of the first land portion to a groove lateral center of the first circumferential narrow groove, have a relationship of 0.5≤(Wt1/W1)≤0.7.

In the above pneumatic tire, it is preferable that a width W2 of the second land portion in the tire lateral direction, and a distance Wt2 in the tire lateral direction from an end portion of the center circumferential main groove on the side of the second land portion to a groove lateral center of the second circumferential narrow groove, have a relationship of 0.3≤(Wt2/W2)≤0.5.

In the above pneumatic tire, it is preferable that a distance We in the tire lateral direction from the tire equator line to the end portion of the center circumferential main groove on the side of the first land portion, and a width Wa1 of the first-land-portion first region in the tire lateral direction, have a relationship of 0.4≤(Wc/Wa1)≤0.6.

In the above pneumatic tire, it is preferable that a relationship between a width Wa1 of the first-land-portion first region in the tire lateral direction and a width Wa2 of the second-land-portion first region in the tire lateral direction, satisfies Wa1>Wa2.

In the above pneumatic tire, it is preferable that a relationship between a width Wb1 of the first-land-portion second region in the tire lateral direction and a width Wb2 of the second land portion second region in the tire lateral direction, satisfies Wb1<Wb2.

In the above pneumatic tire, it is preferable that a groove area ratio Gb1 in the first-land-portion second region is within a range of 3.0%≤Gb1≤15.0%, a groove area ratio Gb2 in the second-land-portion second region is within a range of 3.0%≤Gb2≤15.0%, and a relationship between the groove area ratio Gb1 and the groove area ratio Gb2 satisfies Gb2<Gb1.

In the above pneumatic tire, it is preferable that a region including 30% or more of an extending length of the lateral grooves formed in the first-land-portion second region and the second-land-portion second region, is chamfered.

In the above pneumatic tire, it is preferable that the lateral grooves formed in the first-land-portion second region and the second-land-portion second region are chamfered only on one edge of an opening.

In the above pneumatic tire, it is preferable that lateral sipes are formed in the first-land-portion second region and the second-land-portion second region, first ends of the lateral sipes being connected to the circumferential main groove or the first circumferential narrow groove or the second circumferential narrow groove, and second ends terminating in the first-land-portion second region or the second-land-portion second region, and the lateral sipes and the lateral grooves are alternately disposed in the tire circumferential direction.

In the above pneumatic tire, it is preferable that the second land portion is disposed outside the tire equator line in a vehicle mounting direction.

In the above pneumatic tire, it is preferable that among the plurality of land portions, the land portion located innermost in a vehicle mounting direction is defined as a first shoulder land portion, and the land portion located outermost in the vehicle mounting direction is defined as a second shoulder land portion, shoulder lateral grooves and shoulder lateral sipes extending in the tire lateral direction are formed, respectively, in the first shoulder land portion and the second shoulder land portion, and the shoulder lateral grooves and the shoulder lateral sipes are alternately disposed in the tire circumferential direction.

The pneumatic tire according to the present technology achieves an effect of improving wet steering stability and dry steering stability in a well-balanced manner.

### BRIEF DESCRIPTION OF DRAWINGS

FIG. 1 is a plan view illustrating a tread surface of a pneumatic tire according to an embodiment.

FIG. 2 is a detailed view of portion A of FIG. 1.

FIG. 3 is a cross-sectional view taken along F-F of FIG. 2.

FIG. 4 is a detailed view of portion B of FIG. 1.

FIG. 5 is a detailed view of portion C of FIG. 1.

FIG. 6 is a detailed view of portion D of FIG. 1.

FIG. 7 is a detailed view of portion E of FIG. 1.

FIG. 8 is a detailed view of a center land portion described in FIG. 1.

FIG. 9A is a table showing results of performance tests for pneumatic tires.

FIG. 9B is a table showing results of performance tests for pneumatic tires.

FIG. 9C is a table showing results of performance tests for pneumatic tires.

FIG. 9D is a table showing results of performance tests for pneumatic tires.

### DETAILED DESCRIPTION

Pneumatic tires according to embodiments of the present technology are described in detail below with reference to the drawings. However, the technology is not limited to these embodiments. Constituents of the following embodiments include elements that can be substituted and easily conceived by one skilled in the art, or that are essentially identical.

Herein, “tire lateral direction” refers to the direction that is parallel with a rotation axis of a pneumatic tire. “Inward in the tire lateral direction” refers to the direction toward the tire equatorial plane in the tire lateral direction. “Outward in the tire lateral direction” refers to the direction opposite of the direction toward the tire equatorial plane in the tire lateral direction. “Tire radial direction” refers to the direction orthogonal to the tire rotation axis. “Tire circumferential direction” refers to the direction of rotation about the tire rotation axis.

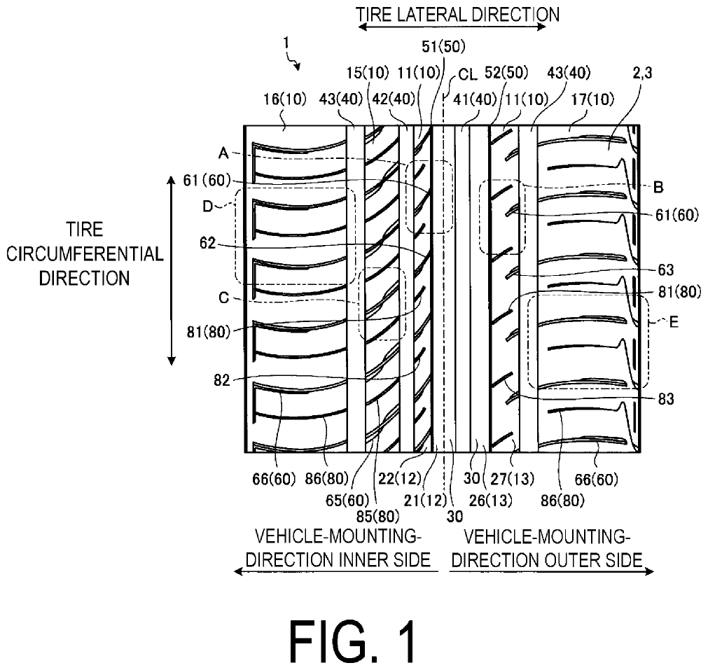

FIG. 1 is a plan view illustrating a tread surface of a pneumatic tire according to an embodiment. For the pneumatic tire 1 illustrated in FIG. 1, a mounting direction with respect to a vehicle, i.e., a direction for when mounted, is designated. That is, in the pneumatic tire 1 according to the present embodiment, a side facing the inside of the vehicle when mounted on the vehicle is the inner side in the vehicle mounting direction, and a side facing the outside of the vehicle when mounted on the vehicle is the outer side in the vehicle mounting direction. Designation of the inner side in the vehicle mounting direction and the outer side in the vehicle mounting direction is not limited to a case where the tire is mounted on the vehicle. For example, since an orientation of the rim is determined with respect to the inner side and the outer side of the vehicle in the tire lateral direction when mounted on a rim, the orientation of the pneumatic tire 1 is designated with respect to the vehicle-mounting-direction inner side and the vehicle-mounting-direction outer side in the tire lateral direction when mounted on the rim. The pneumatic tire 1 includes a mounting direction indicator portion (not illustrated) that indicates the mounting direction with respect to a vehicle. The mounting direction indicator portion, for example, is constituted by a mark or ridges/grooves on the sidewall portion of the tire. For example, Economic Commission for Europe Regulation 30 (ECE R30) requires that the mounting direction indicator portion to be provided on the sidewall portion on the vehicle-mounting-direction outer side in a vehicle mounted state. The pneumatic tire 1 according to the present embodiment is mainly used as the pneumatic tire for a passenger vehicle.

The pneumatic tire 1 according to the present embodiment is provided with a tread portion 2 in an outermost portion in the tire radial direction. A surface of the tread portion 2, that is, a portion which comes into contact with a road surface when a vehicle (not illustrated) mounted with the pneumatic tire 1 runs, is formed as a tread surface 3. A plurality of circumferential main grooves 40 extending in a tire circumferential direction are formed in the tread surface 3, and a plurality of land portions 10 are defined by the plurality of circumferential main grooves 40.

Four circumferential main grooves 40 are provided, among which the circumferential main groove 40 closest to a tire equator line CL in the tire lateral direction is defined as a center circumferential main groove 41. Among the four circumferential main grooves 40, the circumferential main groove 40 having a second closest position with respect to the tire equator line CL in the tire lateral direction is defined as a second circumferential main groove 42. The second circumferential main groove 42 is located on an opposite side of the center circumferential main groove 41 in the tire lateral direction with respect to the tire equator line CL. Among the four circumferential main grooves 40, the two circumferential main grooves 40 located outermost on both sides in the tire lateral direction are defined as outermost circumferential main grooves 43.

The center circumferential main groove 41 is located outside the second circumferential main groove 42 in the vehicle mounting direction. That is, the center circumferential main groove 41 is located outside the tire equator line CL in the vehicle mounting direction, and the second circumferential main groove 42 is located inside the tire equator line CL in the vehicle mounting direction. Groove widths of the circumferential main grooves 40 are within a range from 5 mm to 18 mm, and groove depths thereof are within a range from 6 mm to 10 mm.

Among the plurality of land portions 10 defined by the circumferential main grooves 40, the two land portions 10 defined by the center circumferential main groove 41 which are located on both sides of the center circumferential main groove 41 in the tire lateral direction, are center land portions 11. Among the two center land portions 11, the center land portion 11 having a shorter distance from the tire equator line CL in the tire lateral direction is a first land portion 12, and the other center land portion 11 is a second land portion 13. In this case, in a case where either center land portions 11 of the two center land portions 11 includes the tire equator line CL, this center land portion 11 is defined as the first land portion 12. In the present embodiment, among the two center land portions 11, the first land portion 12 is formed between the center circumferential main groove 41 and the second circumferential main groove 42, and the second land portion 13 is formed between the outermost circumferential main groove 43, which is adjacent to the center circumferential main groove 41, and the center circumferential main groove 41.

The first land portion 12 formed between the center circumferential main groove 41 and the second circumferential main groove 42, is disposed at a position including the tire equator line CL. When viewed from the center circumferential main groove 41 located outside the tire equator line CL in the vehicle mounting direction, the second land portion 13 which is located on a side opposite to a side where the tire equator line CL is located in the tire lateral direction, is disposed outside the tire equator line CL in the vehicle mounting direction.

Among the plurality of land portions 10, the land portion 10 formed between the outermost circumferential main groove 43 which is adjacent to the second circumferential main groove 42 and the second circumferential main groove 42, is a second land portion 15. Among the plurality of land portions 10, the land portion 10 located on a tire-lateral-direction outer side of the outermost circumferential main groove 43 adjacent to the second circumferential main groove 42 is a first shoulder land portion 16, and the land portion 10 located on the tire-lateral-direction outer side of the outermost circumferential main groove 43 adjacent to the center circumferential main groove 41 is a second shoulder land portion 17. That is, the first shoulder land portion 16 is the land portion 10 located innermost in the vehicle mounting direction of the plurality of land portions 10, and the second shoulder land portion 17 is the land portion 10 located outermost in the vehicle mounting direction of the plurality of land portions 10.

Circumferential narrow grooves 50 extending in the tire circumferential direction are formed in each of the two center land portions 11. Specifically, the first land portion 12 has a first circumferential narrow groove 51 which is a circumferential narrow groove 50 extending in the tire circumferential direction, and the second land portion 13 has a second circumferential narrow groove 52 which is a circumferential narrow groove 50 extending in the tire circumferential direction. Groove widths of the circumferential narrow grooves 50 are within a range from 1 mm to 3.5 mm, and groove depths thereof are within a range from 4 mm to 8 mm.

Among regions defined by the first circumferential narrow groove 51 in the first land portion 12 and located on both sides of the first circumferential narrow groove 51 in the tire lateral direction, when the region on the side adjacent to the center circumferential main groove 41 is defined as a first-land-portion first region 21 while the other region is defined as a first-land-portion second region 22, the first-land-portion first region 21 has a plane region 30 where no groove is formed over the entire circumference. In the first land portion 12 disposed at the position including the tire equator line CL, the first-land-portion first region 21 is disposed at a position where the tire equator line CL is included. Similarly, among regions defined by the second circumferential narrow groove 52 in the second land portion 13 and located on both sides of the second circumferential narrow groove 52 in the tire lateral direction, when the region on the side adjacent to the center circumferential main groove 41 is defined as a second-land-portion first region 26 while the other region is defined as a second-land-portion second region 27, the second-land-portion first region 26 has a plane region 30 where no groove is formed over the entire circumference.

Meanwhile, a center lateral groove 61 which is a lateral groove 60 extending in the tire lateral direction, is formed in the first-land-portion second region 22 of the first land portion 12 and the second-land-portion second region 27 of the second land portion 13. A center lateral sipe 81 which is one of lateral sipes 80, is formed in the first-land-portion second region 22 and the second-land-portion second region 27. A first end of the center lateral sipe 81 is connected to the circumferential main groove 40 or the first circumferential narrow groove 51 or the second circumferential narrow groove 52, and a second end of the center lateral sipe 81 is terminated in the first-land-portion second region 22 or the second-land-portion second region 27. The center lateral sipe 81 and the center lateral groove 61 are alternately arranged in the tire circumferential direction.

The sipe mentioned herein refers to a portion formed in a narrow groove shape in the tread surface 3, and when the pneumatic tire 1 is mounted on a regular rim under a regular internal pressure condition, wall surfaces constituting the narrow groove do not contact each other when no load is applied; when the narrow groove is positioned in a portion of a ground contact patch formed on a flat plate when load is applied vertically on the flat plate, or when the land portion where the narrow groove is formed flexes, at least part of the wall surfaces constituting the narrow groove or portions provided on the wall surfaces come into contact with each other due to deformation of the land portion. Here, the “regular rim” refers to a “standard rim” defined by the Japan Automobile Tire Manufacturers Association Inc. (JATMA), a “design rim” defined by the Tire and Rim Association, Inc. (TRA), or a “measuring rim” defined by the European Tire and Rim Technical Organization (ETRTO). The “regular internal pressure” refers to a “maximum air pressure” defined by JATMA, a maximum value in “TIRE LOAD LIMITS AT VARIOUS COLD INFLATION PRESSURES” defined by TRA, or “INFLATION PRESSURES” defined by ETRTO.

A first center lateral groove 62, namely the center lateral groove 61 formed in the first-land-portion second region 22, and a first center lateral sipe 82, namely the center lateral sipe 81 formed in the first-land-portion second region 22, are formed in the first-land-portion second region 22. The first center lateral groove 62 extends in the tire lateral direction and inclines toward the tire circumferential direction with respect to the tire circumferential direction. A first end of the first center lateral groove 62 is connected to the second circumferential main groove 42, and a second end is connected to the first circumferential narrow groove 51. The first center lateral sipe 82 extends in the tire lateral direction and inclines toward the tire circumferential direction in the same direction as an inclination direction of the first center lateral grooves 62 with respect to the tire circumferential direction. A first end of the first center lateral sipe 82 is connected to the second circumferential main groove 42, and a second end is terminated in the first-land-portion second region 22. These first center lateral grooves 62 and first center lateral sipes 82 are alternately arranged in the tire circumferential direction in the first-land-portion second region 22.

A second center lateral groove 63, namely the center lateral groove 61 formed in the second-land-portion second region 27, and a second center lateral sipe 83, namely the center lateral sipe 81 formed in the second-land-portion second region 27, are formed in the second-land-portion second region 27. The second center lateral groove 63 extends in the tire lateral direction and inclines toward the tire circumferential direction with respect to the tire circumferential direction. A first end of the second center lateral groove 63 is connected through the second land portion 13 to the outermost circumferential main groove 43 on the side adjacent to the center circumferential main groove 41, and a second end is terminated in the second-land-portion second region 27. An inclination direction of the second center lateral groove 63 in the tire circumferential direction with respect to the tire lateral direction is the same as the inclination direction of the first center lateral groove 62. The second center lateral sipe 83 extends in the tire lateral direction and inclines toward the tire circumferential direction in the same direction as the inclination direction of the second center lateral grooves 63 with respect to the tire circumferential direction. A first end of the second center lateral sipe 83 is connected to the second circumferential narrow groove 52, and a second end is terminated in the second-land-portion second region 27. These second center lateral grooves 63 and second center lateral sipes 83 are alternately arranged in the tire circumferential direction in the second-land-portion second region 27.

A second lateral groove 65 which is a lateral groove 60 formed in the second land portion 15, and a second lateral sipe 85 which is a lateral sipe 80 formed in the second land portion 15, are formed in the second land portion 15. A first end of the second lateral groove 65 and a first end of the second lateral sipe 85 are connected through the second land portion 15 to the outermost circumferential main groove 43 on the side adjacent to the second circumferential main groove 42, and second ends thereof are connected to the second circumferential main groove 42. The second lateral groove 65 and the second lateral sipe 85 extend in the tire lateral direction and incline toward the tire circumferential direction in the same direction as the inclination direction of the first center lateral groove 62 or the first center lateral sipe 82 with respect to the tire circumferential direction. The second lateral groove 65 and the second lateral sipe 85 are alternately disposed in the tire circumferential direction. Further, the second lateral groove 65 is disposed at a position close to an extension line of the first center lateral groove 62 formed in the first land portion 12, and the second lateral sipe 85 is disposed at a position close to an extension line of the first center lateral sipe 82 formed in the first land portion 12.

A shoulder lateral groove 66 which is one of the lateral grooves 60, and a shoulder lateral sipe 86 which is one of the lateral sipes 80, are formed in the first shoulder land portion 16 and the second shoulder land portion 17. The shoulder lateral groove 66 and the shoulder lateral sipe 86 extend in the tire lateral direction. These shoulder lateral grooves 66 and shoulder lateral sipes 86 are alternately disposed in the first shoulder land portion 16 and the second shoulder land portion 17 in the tire circumferential direction.

Specifically, inner end portions in the tire lateral direction of the shoulder lateral groove 66 and the shoulder lateral sipe 86 formed in the first shoulder land portion 16 are connected to the outermost circumferential main groove 43 and extend outward in the tire lateral direction from the outermost circumferential main groove 43. The shoulder lateral groove 66 and the shoulder lateral sipe 86 formed in the first shoulder land portion 16, extend in the tire lateral direction and are curved in the tire circumferential direction. Further, the shoulder lateral groove 66 of the first shoulder land portion 16 is disposed at a position close to an extension line of the second lateral groove 65 formed in the second land portion 15, and the shoulder lateral sipe 86 of the first shoulder land portion 16 is disposed at a position close to an extension line of the second lateral sipe 85 formed in the second land portion 15.

Inner end portion in the tire lateral direction of the shoulder lateral groove 66 formed in the second shoulder land portion 17 is connected to the outermost circumferential main groove 43 and extends outward in the tire lateral direction from the outermost circumferential main groove 43. Inner end portion in the tire lateral direction of the shoulder lateral sipe 86 formed in the second shoulder land portion 17 is terminated in the second shoulder land portion 17. The shoulder lateral groove 66 and the shoulder lateral sipe 86 formed in the second shoulder land portion 17, extend in the tire lateral direction and are curved in the tire circumferential direction. Further, the shoulder lateral groove 66 of the second shoulder land portion 17 is disposed at a position close to an extension line of the second center lateral groove 63 formed in the second land portion 13, and the shoulder lateral sipe 86 of the second shoulder land portion 17 is disposed at a position close to an extension line of the second center lateral sipe 83 formed in the second land portion 13.

Groove widths of the lateral grooves 60 formed as described above are within a range from 1 mm to 4 mm, and groove depths thereof are within a range from 2 mm to 8 mm. Groove widths of the lateral sipes 80 are within a range of 0.5 mm or more, and less than 1 mm, and groove depths thereof are within a range from 2 mm to 7 mm.

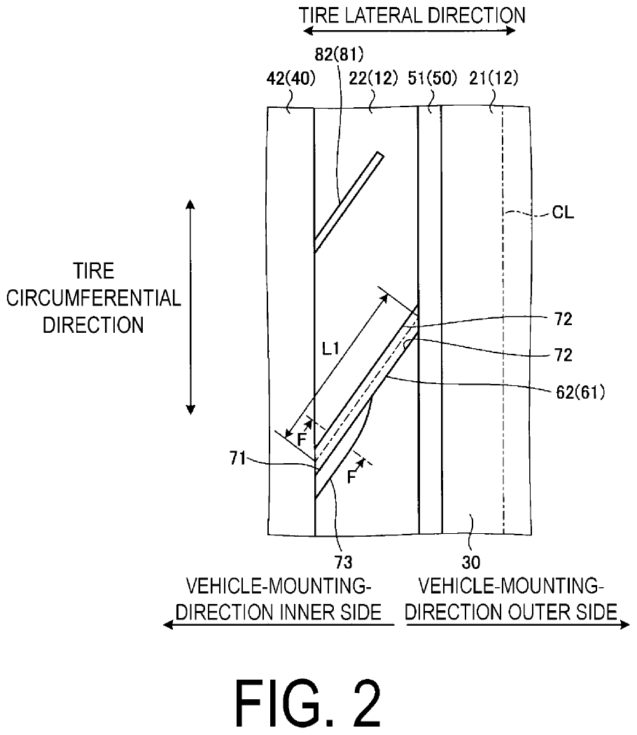

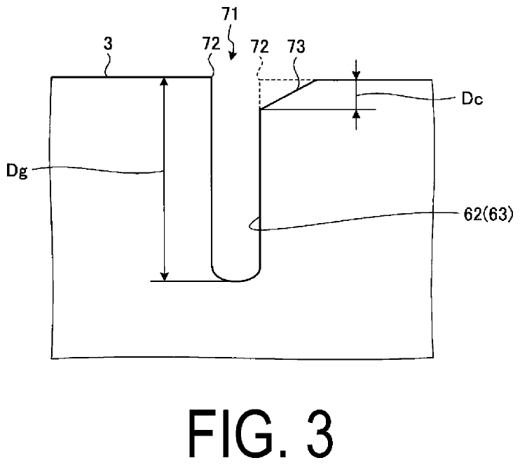

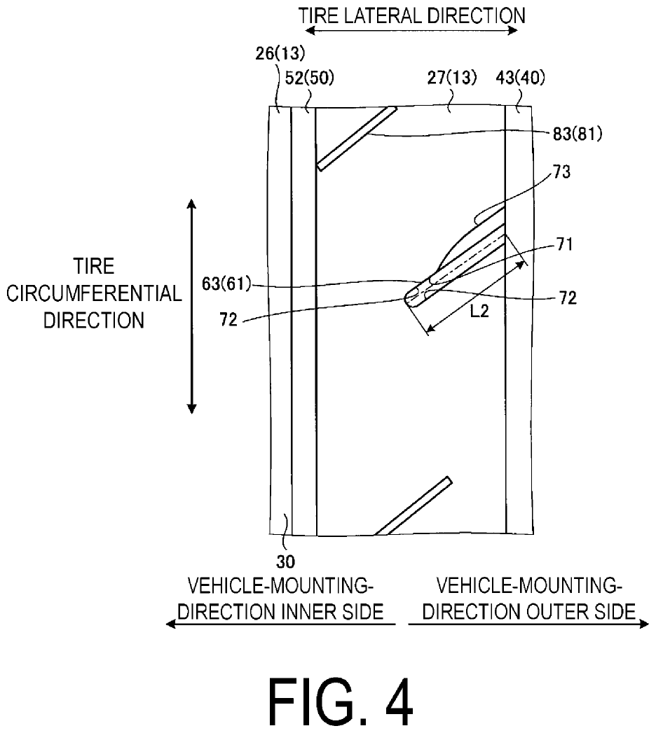

FIG. 2 is a detailed view of portion A of FIG. 1. FIG. 3 is a cross-sectional view taken along F-F of FIG. 2. FIG. 4 is a detailed view of portion B of FIG. 1. Each of the center lateral grooves 61 formed in the first-land-portion second region 22 and the second-land-portion second region 27 has a chamfer 73 formed in a region including 30% or more of an extending length of the center lateral groove 61. The extending length of the center lateral groove 61 in this case is a length in an extension direction at a position of a groove lateral center of each center lateral groove 61. The chamfer 73 of the center lateral groove 61 is formed only on one edge 72 of an opening portion 71 of each center lateral groove 61.

That is, in the first center lateral groove 62, the chamfer 73 is formed only on one edge 72 of the opening portion 71 of the first center lateral groove 62 in a region including 30% or more of an extending length L1 of the first center lateral groove 62. The chamfer 73 formed in the first center lateral groove 62 is formed in the region including 30% or more of the extending length L1 of the first center lateral groove 62 from an end portion on a side connected to the second circumferential main groove 42 in the first center lateral groove 62. A depth Dc, in a depth direction of the first center lateral groove 62 of the chamfer 73 formed in the first center lateral groove 62, is preferably within a range from 10% to 50% of a groove depth Dg of the first center lateral groove 62. Among the edges 72 of the opening portion 71 of each first center lateral groove 62, the chamfer 73 of each of the plurality of first center lateral grooves 62 formed in the first-land-portion second region 22, is formed in the edge 72 which is located on the same side in the tire circumferential direction in each of the first center lateral grooves 62.

In the second center lateral groove 63, the chamfer 73 is formed only on one edge 72 of the opening portion 71 of the second center lateral groove 63 in a region including 30% or more of an extending length L2 of the second center lateral groove 63. The chamfer 73 formed in the second center lateral groove 63 is formed in the region including 30% or more of the extending length L2 of the second center lateral groove 63 from an end portion on a side connected to the outermost circumferential main groove 43 in the second center lateral groove 63. Similar to the chamfer 73 formed in the first center lateral groove 62, the depth Dc, in the depth direction of the second center lateral groove 63 of the chamfer 73 formed in the second center lateral groove 63, is preferably within a range from 10% to 50% of the groove depth Dg of the second center lateral groove 63.

Among the edges 72 of the opening portion 71 of each second center lateral groove 63, the chamfer 73 of each of the plurality of second center lateral grooves 63 formed in the second-land-portion second region 27 is formed in the edge 72 which is located on the same side in the tire circumferential direction in each of the second center lateral grooves 63. A position of the chamfer 73 formed in the second center lateral groove 63 with respect to the second center lateral groove 63 in the tire circumferential direction, is a position opposite to the side where the chamfer 73 of the first center lateral groove 62 is formed with respect to the first center lateral groove 62 in the tire circumferential direction.

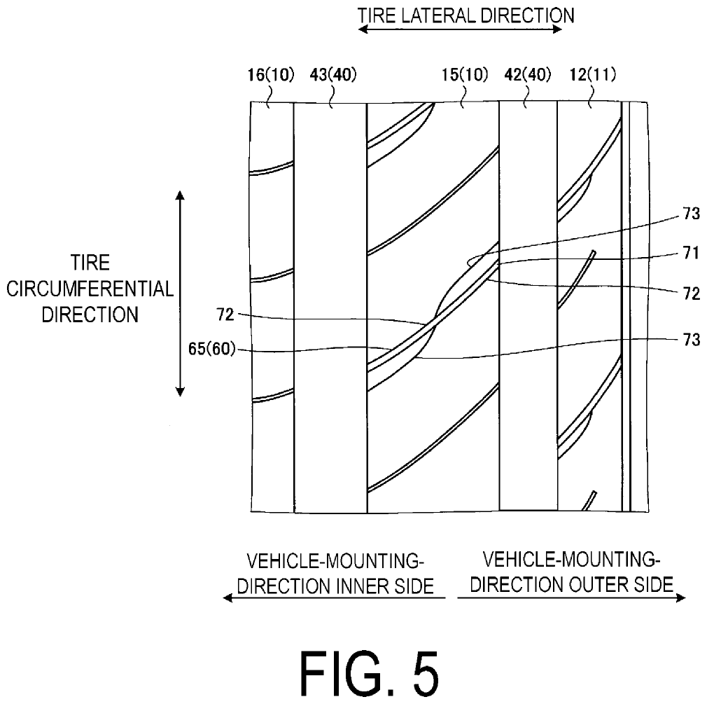

FIG. 5 is a detailed view of portion C of FIG. 1. The chamfer 73 is also formed in the second lateral groove 65 formed in the second land portion 15. Similar to the chamfer 73 formed in the center lateral groove 61, the chamfer 73 formed in the second lateral groove 65 is formed only on one edge 72 of the opening portion 71. In the chamfer 73 of the second lateral groove 65, the edge 72 on a side formed in the opening 71 is changed in a vicinity of a central portion in an extension direction of the second lateral groove 65. In other words, the chamfer 73 of the second lateral groove 65 is formed on one edge 72 of the opening portion 71 in a region from the vicinity of the central portion in the extension direction of the second lateral groove 65 to an end portion of one side, and is formed on the edge 72 of the opening portion 71 in a region from the vicinity of the central portion in the extension direction of the second lateral groove 65 to an end portion of the other side, on the edge 72 on a side where the opening 71 is not formed in the other region.

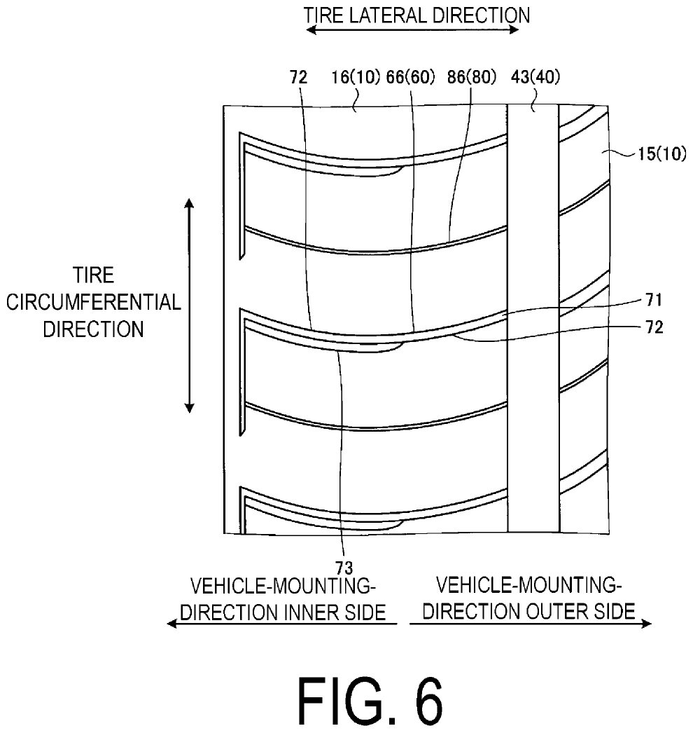

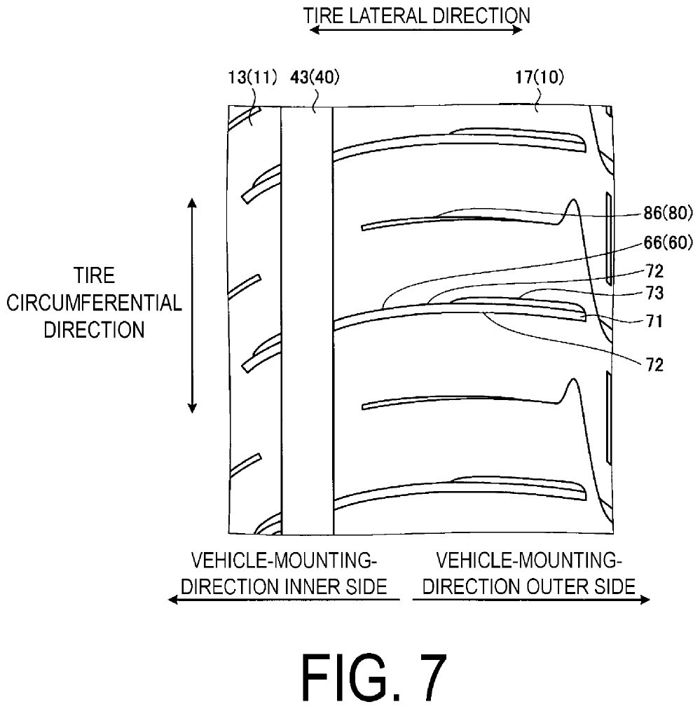

FIG. 6 is a detailed view of portion D of FIG. 1. FIG. 7 is a detailed view of portion E of FIG. 1. The chamfers 73 are also formed in the shoulder lateral groove 66 formed in the first shoulder land portion 16 and the shoulder lateral grooves 66 formed in the second shoulder land portion 17, only on one edges 72 in the opening portions 71. The chamfer 73 of the shoulder lateral groove 66 is formed in a region outside a predetermined position, which is in the extension direction of the shoulder lateral groove 66, in the tire lateral direction. The chamfer 73 formed in the shoulder lateral groove 66 is formed in each of the shoulder lateral grooves 66 of the first shoulder land portion 16 and the second shoulder land portion 17 on the edge 72 on a side where curvature of the shoulder lateral groove 66 becomes convex among the edges 72 on both sides in the tire circumferential direction of the opening portion 71. Therefore, the chamfers 73 are formed in the shoulder lateral groove 66 formed in the first shoulder land portion 16 and the shoulder lateral grooves 66 formed in the second shoulder land portion 17 at positions different from each other in the tire circumferential direction.

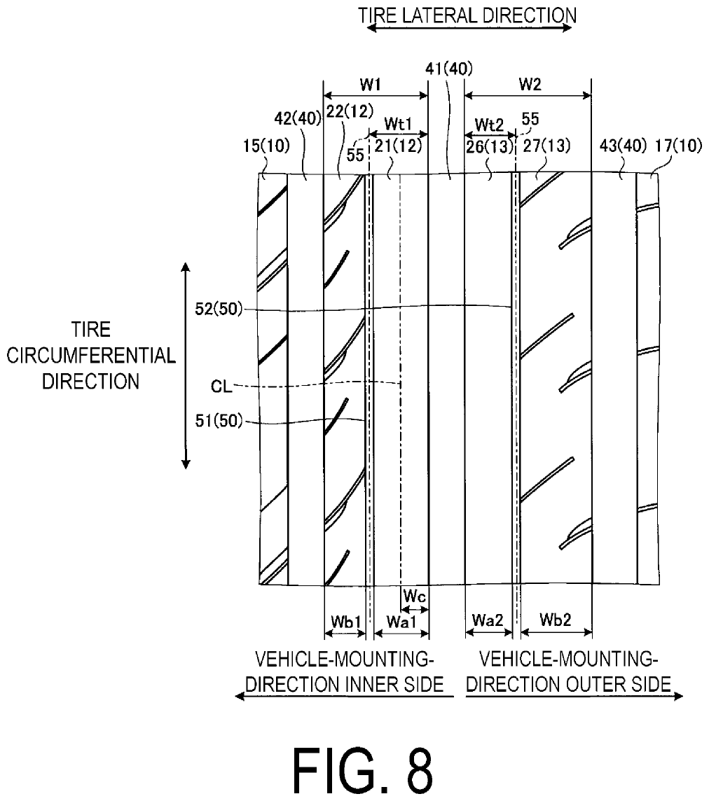

FIG. 8 is a detailed view of a center land portion described in FIG. 1. In the first land portion 12, a width W1 of the first land portion 12 in the tire lateral direction and a distance Wt1 in the tire lateral direction from an end portion of the center circumferential main groove 41 on the side of the first land portion 12 to a groove lateral center 55 of the first circumferential narrow groove 51, have a relationship of 0.5≤(Wt1/W1)≤0.7. In other words, in the first land portion 12, the first circumferential narrow groove 51 is disposed at a position to make the distance Wt1 in the tire lateral direction from the end portion of the center circumferential main groove 41 on the side of the first land portion 12 to the groove lateral center 55 of the first circumferential narrow groove 51 50% to 70% of the width W1 of the first land portion 12 in the tire lateral direction. The first-land-portion first region 21 and the first-land-portion second region 22 are defined by this first circumferential narrow groove 51.

In the second land portion 13, a width W2 of the second land portion 13 in the tire lateral direction and a distance Wt2 in the tire lateral direction from an end portion of the center circumferential main groove 41 on the side of the second land portion 13 to a groove lateral center 55 of the second circumferential narrow groove 52, have a relationship of 0.3≤(Wt2/W2)≤0.5. In other words, in the second land portion 13, the second circumferential narrow groove 52 is disposed at a position to make the distance Wt2 in the tire lateral direction from the end portion of the center circumferential main groove 41 on the side of the second land portion 13 to the groove lateral center 55 of the second circumferential narrow groove 52 30% to 50% of the width W2 of the second land portion 13 in the tire lateral direction. The second-land-portion first region 26 and the second-land-portion second region 27 are defined by this second circumferential narrow groove 52.

In the first land portion 12 disposed at a position including the tire equator line CL, a distance Wc in the tire lateral direction from the tire equator line CL to the end portion of the center circumferential main groove 41 on the side of the first land portion 12, and a width Wa1 of the first-land-portion first region 21 in the tire lateral direction, have a relationship of 0.4≤(Wc/Wa1)≤0.6. In other words, in the first land portion 12, the distance Wc in the tire lateral direction, from the tire equator line CL to the end portion of the center circumferential main groove 41 on the side of the first land portion 12, is 40% to 60% of the width Wa1 of the first-land-portion first region 21 in the tire lateral direction.

In the first land portion 12 and the second land portion 13, a relationship between the width Wa1 of the first-land-portion first region 21 in the tire lateral direction and a width Wa2 of the second-land-portion first region 26 in the tire lateral direction satisfies Wa1>Wa2. In other words, the width Wa1 of the first-land-portion first region 21 is larger than the width Wa2 of the second-land-portion first region 26. In the first land portion 12 and the second land portion 13, a relationship between a width Wb1 of the first-land-portion second region 22 in the tire lateral direction and a width Wb2 of the second-land-portion second region 27 in the tire lateral direction satisfies Wb1<Wb2. In other words, the width Wb2 of the second-land-portion second region 27 is larger than the width Wb1 of the first-land-portion second region 22.

In the first-land-portion second region 22 in which the first center lateral groove 62 and the first center lateral sipe 82 are formed, a groove area ratio Gb1 in the first-land-portion second region 22 is within a range of 3.0%≤Gb1≤15.0%. Similarly, in the second-land-portion second region 27 in which the second center lateral groove 63 and the second center lateral sipe 83 are formed, a groove area ratio Gb2 in the second-land-portion second region 27 is within a range of 3.0%≤Gb2≤15.0%. Further, in the first-land-portion second region 22 and the second-land-portion second region 27, a relationship between the groove area ratio Gb1 in the first-land-portion second region 22 and the groove area ratio Gb2 in the second-land-portion second region 27 satisfies Gb2<Gb1.

Here, the “groove area ratio” is defined as a percentage of groove area/(groove area+ground contact area). The groove area is total opening area of all grooves in a ground contact patch (ground contact region). The groove area and the ground contact area are measured when the pneumatic tire 1 is mounted on a regular rim under a regular internal pressure, while 70% of a regular load is applied. “Regular load” refers a “maximum load capacity” defined by JATMA, the maximum value in “TIRE LOAD LIMITS AT VARIOUS COLD INFLATION PRESSURES” defined by TRA, or “LOAD CAPACITY” defined by ETRTO.

When such a pneumatic tire 1 is mounted on a vehicle and the vehicle is driven, the pneumatic tire 1 rotates while the tread surface 3 of the tread surface 3 located at the bottom comes into contact with the road surface. When a vehicle mounted with the pneumatic tire 1 travels on a dry road surface, a driving force or a braking force is transferred to the road surface, and a turning force is generated by a frictional force between the tread surface 3 and the road surface to make the vehicle travel. When traveling on a wet road surface, water between the tread surface 3 and the road surface enters the circumferential main groove 40, the lateral grooves 60 and the like, and the water between the tread surface 3 and the road surface is drained by these grooves during the traveling. In this way, the tread surface 3 is easily grounded to the road surface, and the vehicle can travel by the frictional force between the tread surface 3 and the road surface.

Here, when the tread surface 3 is grounded to the road surface, a ground load in a vicinity of a center in the tire lateral direction of the tread surface 3, that is, in a vicinity of the tire equator line CL on the tread surface 3, tends to increase regardless of traveling conditions of the vehicle, and a ground region in the vicinity of the tire equator line CL tends to increase regardless of the traveling conditions of the vehicle. In the pneumatic tire 1 according to the present embodiment, the circumferential narrow groove 50 extending in the tire circumferential direction is formed in each of the first land portion 12 and the second land portion 13 disposed on both sides in the tire lateral direction of the center circumferential main groove 41 located in the vicinity of the tire equator line CL. Further, in each of the first land portion 12 and the second land portion 13, the center lateral groove 61 extending in the tire lateral direction is formed in each of the first-land-portion second region 22 and the second-land-portion second region 27 defined by the circumferential narrow groove 50. Since the first land portion 12 and the second land portion 13 are provided with the circumferential narrow groove 50 and the center lateral groove 61, drainage performance in the vicinity of the tire equator line CL can be improved, and steering stability on wet road surfaces can be improved.

The first land portion 12 and the second land portion 13 include the plane regions 30, where no groove is formed over the entire circumference, in the first-land-portion first region 21 and the second-land-portion first region 26 located inside the first-land-portion second region 22 and the second-land-portion second region 27 in the tire lateral direction, which are defined by the circumferential narrow groove 50. In this way, the ground contact area in the vicinity of the tire equator line CL can be increased, and steering stability on the dry road surface can be improved. As a result, the wet steering stability and dry steering stability can be improved in a well-balanced manner.

Since the first land portion first region 21 is disposed at the position including the tire equator line CL, the ground contact area in the vicinity of the tire equator line CL can be reliably ensured, and the steering stability on the dry road surface can be reliably improved. Through disposing the first-land-portion first region 21 at the position including the tire equator line CL, the first-land-portion second region 22 which includes the first center lateral groove 62 and the first center lateral sipe 82, can be disposed in the vicinity of the tire equator line CL, thus drainage performance in the vicinity of the tire equator line CL can be reliably improved. As a result, the wet steering stability and dry steering stability can be reliably improved in a well-balanced manner.

Since the width W1 of the first land portion 12 in the tire lateral direction and the distance W0 in the tire lateral direction from the end portion of the center circumferential main groove 41 on the side of the first land portion 12 to the groove lateral center 55 of the first circumferential narrow groove 51, have the relationship of 0.5≤(Wt1/W1)≤0.7, the steering stability on the dry road surface and the drainage performance in the vicinity of the tire equator line CL can be reliably improved. In other words, when the first land portion 12 is formed with (Wt1/W1)<0.5, the width of the first-land-portion first region 21 in the tire lateral direction, that is, the width of the plane region 30 is too narrow, which may make it difficult to effectively improve the steering stability on the dry road surface. When the first land portion 12 is formed with (Wt1/W1)>0.7, the width of the first-land-portion second region 22 in the tire lateral direction is too narrow, and a region where the first center lateral groove 62 and the first center lateral sipe 82 are formed becomes small, which may make it difficult to effectively improve the drainage performance in the vicinity of the tire equator line CL. In contrast, when the first land portion 12 is formed with 0.5≤(Wt1/W1)≤0.7, the width of the plane region 30 in the first land portion 12 is ensured so that the steering stability on the dry road surface is effectively improved, and the width of the region where the first center lateral groove 62 and the first center lateral sipe 82 are formed is ensured so that the drainage performance in the vicinity of the tire equator line CL can be reliably improved. As a result, the wet steering stability and dry steering stability can be reliably improved in a well-balanced manner.

Since the width W2 of the second land portion 13 in the tire lateral direction and the distance Wt2 in the tire lateral direction, from the end portion of the center circumferential main groove 41 on the side of the second land portion 13 to the groove lateral center 55 of the second circumferential narrow groove 52, have the relationship of 0.3≤(Wt2/W2)≤0.5, the steering stability on the dry road surface and the drainage performance in the vicinity of the tire equator line CL can be reliably improved. In other words, when the second land portion 13 is formed with (Wt2/W2)<0.3, the width of the second-land-portion first region 26 in the tire lateral direction, that is, the width of the plane region 30 is too narrow, which may make it difficult to effectively increase the ground contact area in the vicinity of the tire equator line CL, and make it difficult to effectively improve the steering stability on the dry road surface. When the second land portion 13 is formed with (Wt2/W2)>0.5, the second-land-portion second region 27 where the second center lateral groove 63 and the second center lateral sipe 83 are formed, becomes far away from the tire equator line CL, which may make it difficult to effectively improve the drainage performance in the vicinity of the tire equator line CL. In contrast, when the second land portion 13 is formed with 0.3≤(Wt2/W2)≤0.5, the width of the plane region 30 in the second land portion 13 is ensured so that the steering stability on the dry road surface is effectively improved, and the second-land-portion second region 27 is close to the tire equator line CL so that the drainage performance in the vicinity of the tire equator line CL can be reliably improved. As a result, the wet steering stability and dry steering stability can be reliably improved in a well-balanced manner.

Since the distance We in the tire lateral direction from the tire equator line CL to the end portion of the center circumferential main groove 41 on the side of the first land portion 12, and the width Wa1 of the first-land-portion first region 21 in the tire lateral direction, have the relationship of 0.4≤(Wc/Wa1)≤0.6, the ground contact area of a central region of the tread surface 3 in the tire lateral direction can be reliably ensured. In other words, when the relationship between the first-land-portion first region 21 and the tire equator line CL is (Wc/Wa1)<0.4, or (Wc/Wa1)>0.6, the tire equator line CL greatly deviates from the center of the first-land-portion first region 21 in the tire lateral direction, which may make it difficult to effectively increase the ground contact area of the central region of the tread surface 3 in the tire lateral direction, and make it difficult to effectively improve the steering stability on the dry road surface. In contrast, when the relationship between the first-land-portion first region 21 and the tire equator line CL is 0.4≤(Wc/Wa1)≤0.6, the tire equator line CL is located in the vicinity of the center of the first-land-portion first region 21 in the tire lateral direction, so that the ground contact area of the central region of the tread surface 3 in the tire lateral direction can be effectively increased. As a result, the dry steering stability can be reliably improved.

Since the relationship between the width Wa1 of the first-land-portion first region 21 in the tire lateral direction and the width Wa2 of the second-land-portion first region 26 in the tire lateral direction satisfies Wa1>Wa2, the drainage performance in the vicinity of the tire equator line CL and the steering stability on the dry road surface can be improved in a well-balanced manner. In other words, when the relationship between the first-land-portion first region 21 and the second-land-portion first region 26 is Wa1≤Wa2, the width of the first-land-portion first region 21 is narrower than the width of the second-land-portion first region 26 in the tire lateral direction, so that it is difficult to effectively increase the ground contact area of the central region of the tread surface 3 in the tire lateral direction. Accordingly, with respect to the improvement of the drainage performance in the vicinity of the tire equator line CL provided by the first-land-portion second region 22, it may be difficult to effectively improve the steering stability on the dry road surface by the first-land-portion first region 21. In contrast, when the relationship between the first-land-portion first region 21 and the second-land-portion first region 26 is Wa1>Wa2, the ground contact area of the central region of the tread surface 3 in the tire lateral direction can be effectively increased, so that the drainage performance in the vicinity of the tire equator line CL and the steering stability on the dry road surface can be improved in a well-balanced manner. As a result, the wet steering stability and dry steering stability can be reliably improved in a well-balanced manner.

Since the relationship between the width Wb1 of the first-land-portion second region 22 in the tire lateral direction and the width Wb2 of the second-land-portion second region 27 in the tire lateral direction satisfies Wb1<Wb2, the steering stability on the dry road surface and the drainage performance in the vicinity of the tire equator line CL can be improved in a well-balanced manner. In other words, when the relationship between the first-land-portion second region 22 and the second-land-portion second region 27 is Wb1≥Wb2, the width of the first-land-portion second region 22 increases with respect to the width of the second-land-portion second region 27 in the tire lateral direction, so that the improvement of the drainage performance in the vicinity of the tire equator line CL provided by the first-land-portion second region 22 may become excessive with respect to the improvement of the steering stability on the dry road surface provided by the first-land-portion first region 21 and the second-land-portion first region 26. In contrast, when the relationship between the first-land-portion second region 22 and the second-land-portion second region 27 is Wb1<Wb2, excessive width of the first-land-portion second region 22 in the tire lateral direction can be reduced, so that the improvement of the steering stability on the dry road surface provided by the first-land-portion first region 21 and the second-land-portion first region 26, and the improvement of the drainage performance in the vicinity of the tire equator line CL provided by the first-land-portion second region 22, can be improved in a well-balanced manner. As a result, the wet steering stability and dry steering stability can be reliably improved in a well-balanced manner.

Since the groove area ratio Gb1 in the first-land-portion second region 22 and the groove area ratio Gb2 in the second-land-portion second region 27 are both within the range of 3.0%≤Gb1≤15.0% and 3.0%≤Gb2≤15.0%, rigidity and drainage performance of the land portion 10 in the vicinity of the tire equator line CL can be ensured in a well-balanced manner. In other words, when the groove area ratios Gb1 and Gb2 are Gb1<3.0% and Gb2<3.0%, the groove area ratios in the first-land-portion second region 22 and the second-land-portion second region 27 is too low, so that it may be difficult to effectively improve the drainage performance in the vicinity of the tire equator line CL. When the groove area ratios Gb1 and Gb2 are Gb1>15.0% and Gb2>15.0%, the groove area ratios in the first-land-portion second region 22 and the second-land-portion second region 27 are too high, the rigidity of the first-land-portion second region 22 in the first land portion 12 and the rigidity of the second-land-portion second region 27 in the second land portion 13 are too low, and it may be difficult to effectively improve the steering stability on the dry road surface. In contrast, when the groove area ratios Gb1 and Gb2 are within the range of 3.0%≤Gb1≤15.0% and 3.0%≤Gb2≤15.0%, the rigidity of the first land portion 12 or the second land portion 13 is not too low, and the drainage performance in the vicinity of the tire equator line CL can be ensured. As a result, the wet steering stability and dry steering stability can be reliably improved in a well-balanced manner.

Since the relationship between the groove area ratio Gb1 and the groove area ratio Gb2 satisfies Gb2<Gb1, the rigidity and drainage performance of the land portion 10 in the vicinity of the tire equator line CL can be ensured in a well-balanced manner. In other words, when the groove area ratios Gb1 and Gb2 are Gb2≥Gb1, the groove area ratio in the first-land-portion second region 22 is too low, hence it may be difficult to effectively improve the drainage performance in the vicinity of the tire equator line CL, and the rigidity of the second-land-portion second region 27 in the second land portion 13 may become too low. In contrast, when the groove area ratios Gb1 and Gb2 are Gb2<Gb1, the drainage performance in the vicinity of the tire equator line CL can be effectively improved, and the rigidity of the second land portion 13 can be prevented from becoming too low, which can improve the drainage performance in the vicinity of the tire equator line CL and the steering stability on the dry road surface in a well-balanced manner. As a result, the wet steering stability and dry steering stability can be reliably improved in a well-balanced manner.

Since the center lateral grooves 61 formed in the first-land-portion second region 22 and the second-land-portion second region 27 have the chamfers 73 formed in the regions including 30% or more of the extending lengths of the center lateral grooves 61, the rigidity of the first land portion 12 and the second land portion 13 is ensured, and the groove area of the first-land-portion second region 22 and the second-land-portion second region 27 can be ensured when the pneumatic tire 1 is new. As a result, the wet steering stability and dry steering stability can be reliably improved in a well-balanced manner.

Since the chamfer 73 is formed only on one edge 72 of the opening portion 71 in the center lateral groove 61 formed in the first-land-portion second region 22 and the second-land-portion second region 27, change in the groove area can be reduced even when the chamfer 73 is worn along with wear of the tread surface 3. As a result, the wet steering stability and dry steering stability can be stably improved in a well-balanced manner.

Since the center lateral sipes 81 and the center lateral grooves 61 are alternately disposed in the tire circumferential direction in the first-land-portion second region 22 and the second-land-portion second region 27, the rigidity of the first land portion 12 and the second land portion 13 is prevented from changing greatly according to positions in the tire circumferential direction, and the rigidity of the first land portion 12 and the second land portion 13 can be made appropriate. As a result, the wet steering stability and dry steering stability can be reliably improved.

Since the second land portion 13 is disposed outside the tire equator line CL in the vehicle mounting direction, the second-land-portion first region 26, which includes the plane region 30, can be disposed outside the first land portion 12 in the vehicle mounting direction. In this way, the ground contact region is increased when the vehicle turns, while ground contact area of a region outside the tire equator line CL in the vehicle mounting direction can be increased, and the steering stability during turning of the vehicle can be improved. As a result, the dry steering stability can be reliably improved.

Since the shoulder lateral groove 66 and the shoulder lateral sipe 86 are formed in the first shoulder land portion 16 and the second shoulder land portion 17, drainage performance can be ensured in a region in a vicinity of an outer side in the tire lateral direction in the ground contact region. Since the shoulder lateral grooves 66 and the shoulder lateral sipes 86 of the first shoulder land portion 16, and shoulder lateral grooves 66 and shoulder lateral sipes 86 of the second shoulder land portion 17 are alternately disposed in the tire circumferential direction, rigidity of the first shoulder land portion 16 and the second shoulder land portion 17 is prevented from changing greatly according to positions in the tire circumferential direction. In this way, the rigidity of the first shoulder land portion 16 and the second shoulder land portion 17 can be made appropriate. As a result, the wet steering stability and dry steering stability can be reliably improved.

Although four circumferential main grooves 40 are formed in the pneumatic tire 1 according to the embodiment described above, the number of the circumferential main grooves 40 may not be four, and the number of the circumferential main grooves 40 may be, for example, three. When the number of the circumferential main grooves 40 is three while the tire equator line CL is included in a central of the circumferential main grooves 40, the circumferential main groove 40 including the tire equator line CL is defined as a center circumferential main groove 41, and the land portions 10 located on both sides of the center circumferential main groove 41 in the tire lateral direction are defined as the first land portion 12 and the second land portion 13. Even when the number of the circumferential main grooves 40 is an even number, in a case where there is one circumferential main groove 40 which includes the tire equator line CL, this circumferential main groove 40 is defined as the center circumferential main groove 41. Three or more circumferential main grooves 40 may be formed as described above.

When there are two circumferential main grooves 40 having substantially a same distance from the tire equator line CL among the plurality of circumferential main grooves 40, either one of the two circumferential main grooves 40 is defined as the center circumferential main groove 41, and the land portions 10 located on both sides of the center circumferential main groove 41 in the tire lateral direction are defined as the first land portion 12 and the second land portion 13. When center land portions 11 located on both sides of the center circumferential main groove 41 in the tire lateral direction have substantially an equal distance to the tire equator line CL, it is preferable that the center land portion 11 located on an inner side in the vehicle mounting direction is defined the first land portion 12, and the center land portion 11 located on an outer side in the vehicle mounting direction is defined as the second land portion 13.

In the pneumatic tire 1 according to the embodiment described above, the two ends of the first center lateral groove 62 are connected to the second circumferential main groove 42 and the first circumferential narrow groove 51, and a first end of the second center lateral groove 63 is connected to the outermost circumferential main groove 43 while a second end is terminated in the second-land-portion second region 27, but the center lateral groove 61 may have other forms. For example, in the center lateral groove 61, a first end of the first center lateral sipe 82 may be terminated in the first-land-portion second region 22. In the pneumatic tire 1 according to the embodiment described above, a first end of the first center lateral sipe 82 is connected to the second circumferential main groove 42 while a second end is terminated in the first-land-portion second region 22, and a first end of the second center lateral sipe 83 is connected to the second circumferential narrow groove 52 while a second end is terminated in the second-land-portion second region 27, but the center lateral sipe 81 may have other forms. For example, in the center lateral sipe 81, a first end of the first center lateral sipe 82 may be connected to the first circumferential narrow groove 51. As described above, the lateral grooves 60 and the lateral sipe 80 may be in a form different from the form described in the embodiment described above.

### Examples

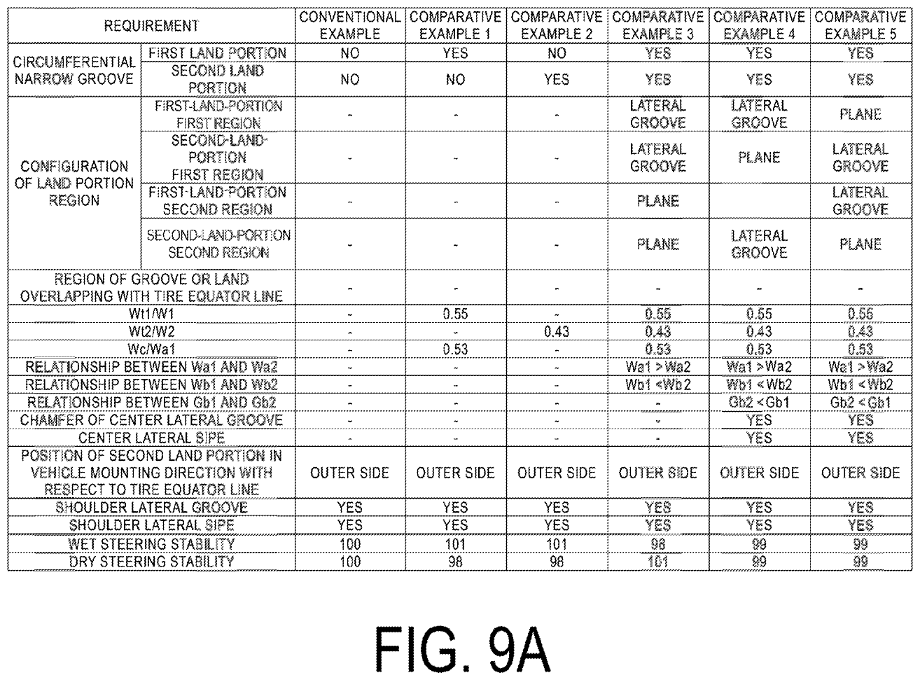

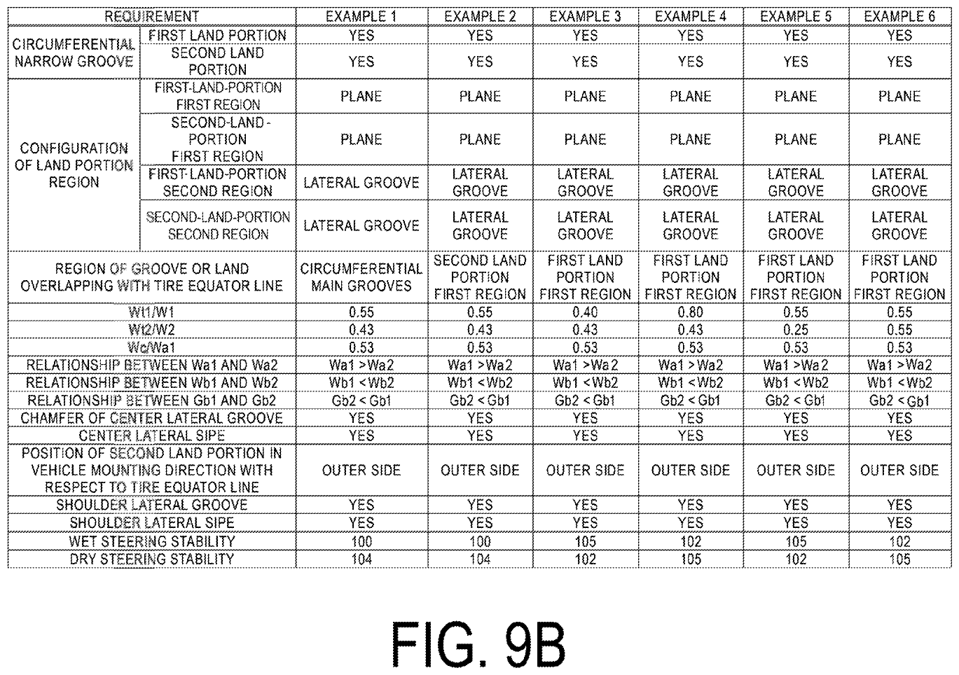

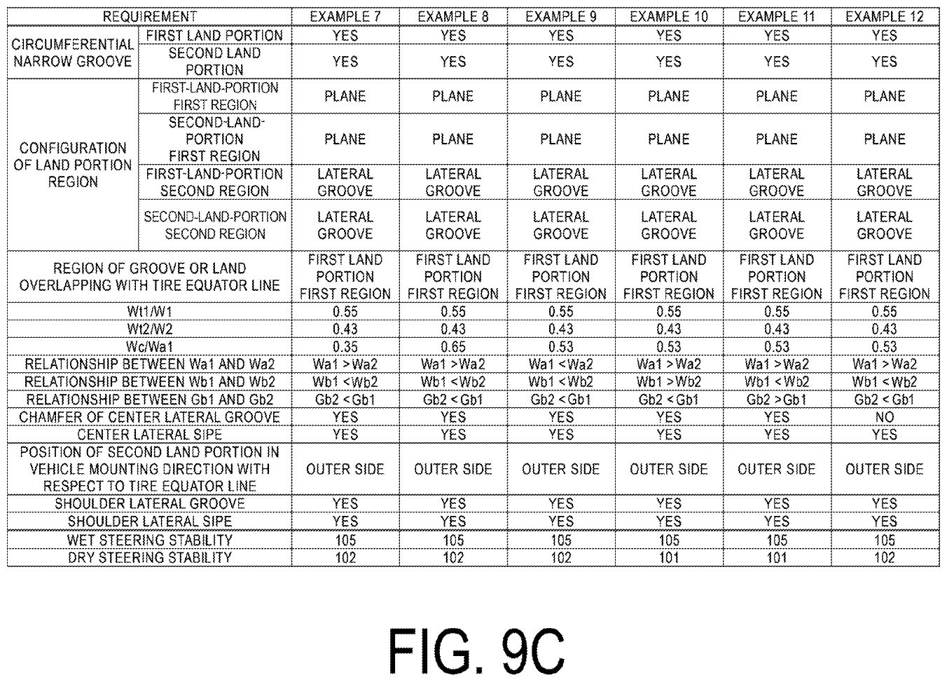

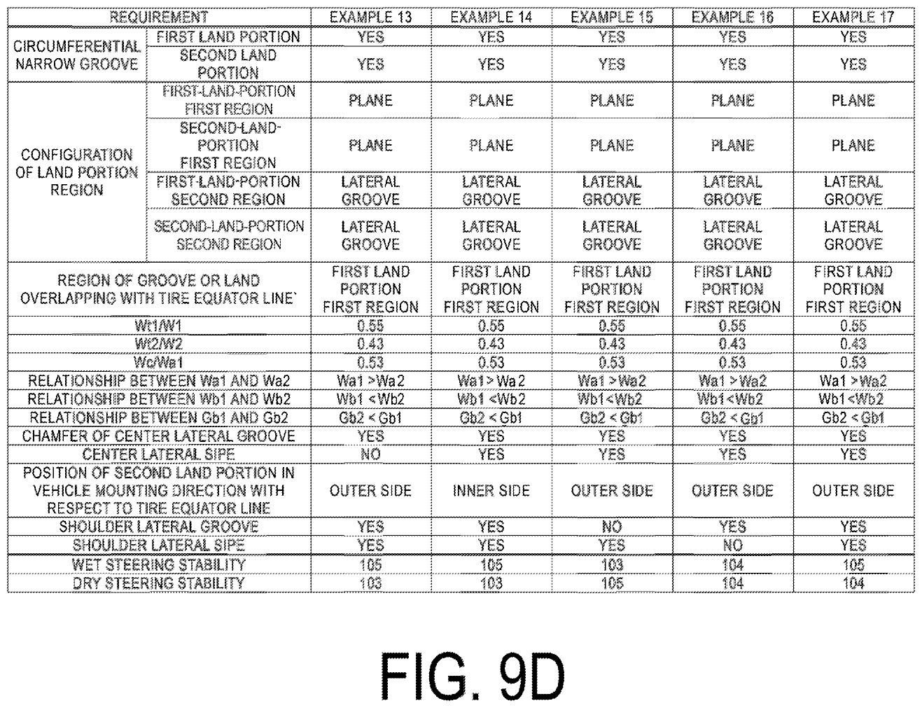

FIG. 9A to FIG. 9D are tables showing results of a performance test for pneumatic tires. Hereinafter, a performance evaluation test performed on pneumatic tires of conventional examples, the pneumatic tires 1 according to the present technology, and pneumatic tires of comparative examples to be compared with the pneumatic tires 1 according to the present technology will be described. The performance evaluation test was conducted on wet steering stability, which is the steering stability when traveling on a wet road surface, and dry steering stability, which is the steering stability when traveling on a dry road surface.

In the performance evaluation test, the pneumatic tires 1 having a size of 215/55R17 94W were mounted on JATMA standard rim wheels having a size of 17×7JJ, and a test travel was performed by mounting the pneumatic tires 1 to a front-wheel drive test vehicle having an engine displacement of 1600 cc while air pressure was adjusted to 230 kPa. As for evaluation methods of each test item, for the wet steering stability, the test vehicle was subjected to traveling on a wet road surface for a test course and a feeling evaluation test of steering stability was performed by a test driver to index evaluation results. The wet steering stability is shown by an index in which an evaluation result of Conventional Example described later is set to 100, while a greater value indicates better wet steering stability. For the dry steering stability, the test vehicle was subjected to traveling on a dry road surface for a test course and a feeling evaluation test of steering stability was performed by a test driver to index evaluation results. The dry steering stability is shown by an index in which an evaluation result of Conventional Example described later is set to 100, while a greater value indicates better wet steering stability.

The evaluation test was performed on 23 types of pneumatic tires including: a pneumatic tire of Conventional Example as an example of a known pneumatic tire 1; Examples 1 to 17, which are the pneumatic tires 1 according to the present technology; and Comparative Examples 1 to 5, which are pneumatic tires to be compared with the pneumatic tires 1 according to the present technology. Among these pneumatic tires 1, in the pneumatic tires of Conventional Example, no circumferential narrow groove is provided in the first land portion and the second land portion located on both sides of the center circumferential main groove in the tire lateral direction. In the pneumatic tires of Comparative Examples 1 to 5, no circumferential narrow groove is provided in the first land portion or the second land portion, and the pneumatic tires of Comparative Examples 1 to 5 have no plane region formed in the first-land-portion first region and no lateral groove formed in the first-land-portion second region and the second-land-portion second region.

In contrast, in all of Examples 1 to 17, which are examples of the pneumatic tires 1 according to the present technology: the circumferential narrow grooves 50 are formed in the first land portion 12 and the second land portion 13; both the first-land-portion first region 21 and the second-land-portion first region 26 have the plane regions 30; and the first-land-portion second region 22 and the second-land-portion second region 27 have center lateral grooves 61. The pneumatic tires 1 according to Examples 1 to 17 have differences with each other in the following items: relative positional relationships between the first land portion 12 and the first-land-portion first region 21, the second land portion 13 and the second-land-portion first region 26, the tire equator line CL and the first-land-portion first region 21, and the tire equator line CL and the second land portion 13; relative relationships between the groove area ratios of the first-land-portion second region 22 and the second-land-portion second region 27; presence of the chamfer 73 of the center lateral groove 61; presence of the center lateral sipe 81; presence of the shoulder lateral groove 66; and presence of the shoulder lateral sipe 86.

As a result of the evaluation test using these pneumatic tires 1, as shown in FIG. 9A to FIG. 9D, the pneumatic tires 1 of Examples 1 to 17, as compared with Conventional Example and Comparative Examples 1 to 5, can improve at least one of the wet steering stability and dry steering stability without deteriorating either of the wet steering stability or dry steering stability. In other words, the pneumatic tires 1 according to Examples 1 to 17 can improve the wet steering stability and dry steering stability in a well-balanced manner.

1. A pneumatic tire, comprising:
three or more circumferential main grooves formed in a tread surface and extending in a tire circumferential direction; and
a plurality of land portions defined by the circumferential main grooves, wherein
among the circumferential main grooves, the circumferential main groove whose position in a tire lateral direction is closest to a tire equator line is defined as a center circumferential main groove,
among the two land portions defined by the center circumferential main groove and located on both sides of the center circumferential main groove in the tire lateral direction, the land portion whose distance to the tire equator line in the tire lateral direction is closer is defined as a first land portion, and the other land portion is defined as a second land portion,
the first land portion includes a first circumferential narrow groove extending in the tire circumferential direction,
the second land portion includes a second circumferential narrow groove extending in the tire circumferential direction,
among regions of the first land portion defined by the first circumferential narrow groove and located on both sides of the first circumferential narrow groove in the tire lateral direction, a region on a side adjacent to the center circumferential main groove is defined as a first-land-portion first region, and a region on the other side is defined as a first-land-portion second region,
among regions of the second land portion defined by the second circumferential narrow groove and located on both sides of the second circumferential narrow groove in the tire lateral direction, a region on a side adjacent to the center circumferential main groove is defined as a second-land-portion first region, and a region on the other side is defined as a second-land-portion second region,
the first-land-portion first region and the second-land-portion first region each include a plane region in which no groove is formed over an entire circumference, and
a lateral groove extending in the tire lateral direction is formed in the first-land-portion second region and the second-land-portion second region.

2. The pneumatic tire according to claim 1, wherein
the first-land-portion first region is disposed at a position including the tire equator line.

3. The pneumatic tire according to claim 1, wherein
a width W1 of the first land portion in the tire lateral direction and a distance Wt1 in the tire lateral direction from an end portion of the center circumferential main groove on the side of the first land portion to a groove lateral center of the first circumferential narrow groove, have a relationship of 0.5≤(Wt1/W1)≤0.7.

4. The pneumatic tire according to claim 1, wherein
a width W2 of the second land portion in the tire lateral direction and a distance Wt2 in the tire lateral direction from an end portion of the center circumferential main groove on the side of the second land portion to a groove lateral center of the second circumferential narrow groove, have a relationship of 0.3≤(Wt2/W2)≤0.5.

5. The pneumatic tire according to claim 1, wherein
a distance We in the tire lateral direction from the tire equator line to the end portion of the center circumferential main groove on the side of the first land portion, and a width Wa1 of the first-land-portion first region in the tire lateral direction have a relationship of 0.4≤(Wc/Wa1)≤0.6.

6. The pneumatic tire according to claim 1, wherein
a relationship between a width Wa1 of the first-land-portion first region in the tire lateral direction and a width Wa2 of the second-land-portion first region in the tire lateral direction satisfies Wa1>Wa2.

7. The pneumatic tire according to claim 1, wherein
a relationship between a width Wb1 of the first-land-portion second region in the tire lateral direction and a width Wb2 of the second land portion second region in the tire lateral direction satisfies Wb1<Wb2.

8. The pneumatic tire according to claim 1, wherein
a groove area ratio Gb1 in the first land portion second region is within a range of 3.0%≤Gb1≤15.0%,
a groove area ratio Gb2 in the second land portion second region is within a range of 3.0%≤Gb2≤15.0%, and
a relationship between the groove area ratio Gb1 and the groove area ratio Gb2 satisfies Gb2<Gb1.

9. The pneumatic tire according to claim 1, wherein
a region including 30% or more of an extending length of the lateral grooves formed in the first-land-portion second region and the second-land-portion second region is chamfered.

10. The pneumatic tire according to claim 1, wherein
the lateral grooves formed in the first-land-portion second region and the second-land-portion second region are chamfered only on one edge of an opening.

11. The pneumatic tire according to claim 1, wherein
lateral sipes are formed in the first-land-portion second region and the second-land-portion second region, first ends of the lateral sipes being connected to the circumferential main groove or the first circumferential narrow groove or the second circumferential narrow groove, and second ends terminating in the first-land-portion second region or the second-land-portion second region, and
the lateral sipes and the lateral grooves are alternately disposed in the tire circumferential direction.

12. The pneumatic tire according to claim 1, wherein
the second land portion is disposed outside the tire equator line in a vehicle mounting direction.

13. The pneumatic tire according to claim 1, wherein
among the plurality of land portions, the land portion located innermost in a vehicle mounting direction is defined as a first shoulder land portion, and the land portion located outermost in the vehicle mounting direction is defined as a second shoulder land portion,
shoulder lateral grooves and shoulder lateral sipes extending in the tire lateral direction are formed, respectively, in the first shoulder land portion and the second shoulder land portion, and
the shoulder lateral grooves and the shoulder lateral sipes are alternately disposed in the tire circumferential direction.

14. The pneumatic tire according to claim 2, wherein
a width W1 of the first land portion in the tire lateral direction and a distance Wt1 in the tire lateral direction from an end portion of the center circumferential main groove on the side of the first land portion to a groove lateral center of the first circumferential narrow groove, have a relationship of 0.5≤(Wt1/W1)≤0.7.

15. The pneumatic tire according to claim 14, wherein
a width W2 of the second land portion in the tire lateral direction and a distance Wt2 in the tire lateral direction from an end portion of the center circumferential main groove on the side of the second land portion to a groove lateral center of the second circumferential narrow groove, have a relationship of 0.3≤(Wt2/W2)≤0.5.

16. The pneumatic tire according to claim 15, wherein
a distance We in the tire lateral direction from the tire equator line to the end portion of the center circumferential main groove on the side of the first land portion, and a width Wa1 of the first-land-portion first region in the tire lateral direction have a relationship of 0.4≤(Wc/Wa1)≤0.6.

17. The pneumatic tire according to claim 16, wherein
a relationship between a width Wa1 of the first-land-portion first region in the tire lateral direction and a width Wa2 of the second-land-portion first region in the tire lateral direction satisfies Wa1>Wa2.

18. The pneumatic tire according to claim 17, wherein
a relationship between a width Wb1 of the first-land-portion second region in the tire lateral direction and a width Wb2 of the second land portion second region in the tire lateral direction satisfies Wb1<Wb2.

19. The pneumatic tire according to claim 18, wherein
a groove area ratio Gb1 in the first land portion second region is within a range of 3.0%≤Gb1≤15.0%,
a groove area ratio Gb2 in the second land portion second region is within a range of 3.0%≤Gb2≤15.0%, and
a relationship between the groove area ratio Gb1 and the groove area ratio Gb2 satisfies Gb2<Gb1.

20. The pneumatic tire according to claim 19, wherein
a region including 30% or more of an extending length of the lateral grooves formed in the first-land-portion second region and the second-land-portion second region is chamfered.
